(19) United States
(12) Patent Application Publication
(10) Pub. No.: US 2026/0180300 A1
(43) Pub. Date: Jun. 25, 2026

(54) WIRE HARNESS AND LIGHTING SYSTEM

(71) Applicant: Sumitomo Wiring Systems, Ltd., Yokkaichi-shi (JP)

(72) Inventors: Miyu MIZUTANI, Yokkaichi-shi (JP); Mitsuhiro Shimamura, Yokkaichi-shi (JP); Hiroki Uno, Yokkaichi-shi (JP); Takashi Kambe, Yokkaichi-shi (JP); Go Ueno, Yokkaichi-shi (JP)

(73) Assignee: Sumitomo Wiring Systems, Ltd., Yokkaichi-shi (JP)

(21) Appl. No.: 19/413,331

(22) Filed: Dec. 9, 2025

(30) Foreign Application Priority Data
Dec. 24, 2024 (JP) 2024-227002

(51) Int. Cl. H02G 3/30; B60Q 3/62; B60Q 3/80; B60R 16/02; B60R 16/033; F21V 23/00; F21V 23/02; F21W 106/00

(52) U.S. Cl. CPC H02G 3/30; B60Q 3/62; B60Q 3/80; B60R 16/0215; F21V 23/001; F21V 23/02; B60R 16/033; F21W 2106/00

(57) ABSTRACT

A wire harness that includes: a plurality of electric wires that is configured to be routed from a vehicle body to a sliding door that opens and closes relative to the vehicle body; and at least one lighting member that extends along an extending direction of the plurality of electric wires and is aligned along the extending direction of the plurality of electric wires.

### BACKGROUND

The present disclosure relates to a wire harness and a lighting system.

Conventionally, there is a lighting system that includes a power supply control device provided in a vehicle body, a light emitting member provided in a sliding door, and a wire harness connecting them to each other (e.g., see JP 2003-327041A). In such a lighting system, while the sliding door is open, the light emitting member can illuminate an area outside the vehicle compartment in a vicinity of the sliding door. Therefore, while the sliding door is open, a user can easily get in and out of the vehicle.

### SUMMARY

A wire harness such as that described above generally does not have a color that stands out, and therefore, for example, when the sliding door is open at night, there is a risk of the wire harness being stepped on when a user gets in or out of the vehicle.

An exemplary aspect of the disclosure provides a wire harness and a lighting system that make it easier to check the position of the wire harness even at night.

A wire harness according to an aspect of the present disclosure is a wire harness having a plurality of electric wires to be routed from a vehicle body to a sliding door that opens and closes relative to the vehicle body, the wire harness including: a lighting member extending along an extending direction of the plurality of electric wires, or a plurality of lighting members aligned along the extending direction of the plurality of electric wires.

According to the wire harness and lighting system of the present disclosure, the position of the wire harness can be easily checked even at night.

### BRIEF DESCRIPTION OF THE DRAWINGS

FIG. 1 is a schematic diagram of a portion of a vehicle in an embodiment, with a sliding door in a fully closed state, as viewed from above;

FIG. 2 is a schematic diagram of a portion of the vehicle in the embodiment while the sliding door is in operation, as viewed from above;

FIG. 3 is a schematic diagram of a portion of the vehicle in the embodiment, with the sliding door in a fully open state, as viewed from above;

FIG. 4 is a schematic cross-sectional view illustrating a wire harness according to the embodiment;

FIG. 5 is a perspective view of a fixing member according to the

### Embodiment;

FIG. 6 is a partial exploded perspective view of the wire harness according

### To the Embodiment;

FIG. 7 is a plan view for describing a type of cable carrier link in the

### Embodiment;

FIG. 8 is a plan view for describing a type of cable carrier link in the embodiment; and

FIG. 9 is a schematic cross-sectional view for describing a wire harness according to another example.

### DETAILED DESCRIPTION OF EMBODIMENTS

### Description of Embodiments of the Present Disclosure

First, embodiments of the present disclosure will be listed and described.

A wire harness according to an aspect of the present disclosure is

[1] a wire harness having a plurality of electric wires to be routed from a vehicle body to a sliding door that opens and closes relative to the vehicle body, the wire harness including: a lighting member extending along an extending direction of the plurality of electric wires, or a plurality of lighting members aligned along the extending direction of the plurality of electric wires.

According to this configuration, the lighting member extends along the extending direction of the electric wires, or a plurality of lighting members are aligned in the extending direction of the electric wires, and therefore even at night, for example, the position of the wire harness can be easily checked when the sliding door is opened. This makes it possible to reduce the risk of the wire harness being stepped on.

[2] A configuration is possible in which, in aspect [1], the lighting member includes a light emitting member and a light guide that extends along the extending direction of the plurality of electric wires and disperses and emits light supplied by the light emitting member while guiding the light along an extending direction of the light guide.

According to this configuration, the lighting member includes the light emitting member and the light guide that extends along the extending direction of the electric wires and disperses and emits the light supplied by the light emitting member while guiding the light along the extending direction, thereby making it possible to achieve good visibility with a simple configuration. For example, a simple configuration including the light emitting member and one light guide can be used to provide long and continuous lighting in the extending direction of the electric wires.

[3] A configuration is possible in which, in aspect [2], the wire harness further includes: an exterior member configured to cover the plurality of electric wires while extending along the extending direction of the plurality of electric wires; and a plurality of fixing members configured to be arranged at intervals in an extending direction of the exterior member, each of the fixing members having a fixing portion configured to be fixed to a portion of the exterior member in the extending direction of the exterior member, and a holding portion configured to hold the light guide.

According to this configuration, the wire harness includes the fixing members that are arranged at intervals in the extending direction of the exterior member, and that each have the fixing portion configured to be fixed to a portion of the exterior member in the extending direction of the exterior member, and the holding portion configured to hold the light guide, and therefore the light guide can be easily routed along the wire harness.

[4] A configuration is possible in which, in aspect [3], each of the holding portions is configured to hold the light guide from a direction intersecting the extending direction of the light guide.

According to this configuration, the holding portion is configured to hold the light guide from a direction intersecting the extending direction of the light guide, and therefore there is no need to, for example, route the light guide along the extending direction in advance, and so-called retrofitting is possible, thus making assembly easier.

[5] A configuration is possible in which, in aspect [3] or [4], each of the fixing portions is configured to be fixed the exterior member from a direction intersecting the extending direction of the exterior member.

According to this configuration, the fixing portion is configured to be fixed to the exterior member from a direction intersecting the extending direction of the exterior member, and therefore there is no need to, for example, route the exterior member along the extending direction in advance, and so-called retrofitting is possible, thus making assembly easier.

[6] A configuration is possible in which, in aspect [5], the exterior member is a rubber boot having a bellows structure with repeating recesses and protrusions in the extending direction of the exterior member, and the fixing portions are fitted into recesses of the bellows structure of the rubber boot.

According to this configuration, the fixing portions are formed so as to be fitted into recesses of the bellows structure of the rubber boot serving as the exterior member, and therefore positional displacement in the extending direction of the exterior member can be prevented with a simple configuration.

[7] A configuration is possible in which, in any one of aspects [1] to [6], the wire harness further includes: a plurality of cable carrier links configured to cover the plurality of electric wires, be aligned along the extending direction of the plurality of electric wires, and be rotatably connected to each other.

According to this configuration, the wire harness includes the cable carrier links that cover the electric wires, are aligned along the extending direction of the electric wires, and are rotatably connected to each other, and therefore, for example, the position of the wire harness can be stabilized. For example, with a configuration in which the electric wires are merely covered with a simple corrugated tube, the wire harness can bend freely at any position in the extending direction, and the manner of bending may change due to deterioration or the like, and therefore the position of the wire harness is not stable. In contrast, the cable carrier links can maintain a constant manner of bending even when the sliding door is repeatedly opened and closed, and therefore the position of the wire harness can be stabilized. Therefore, for example, it is possible to prevent the wire harness from protruding to a position where it is likely to be stepped on.

A lighting system according to an aspect of the present disclosure includes:

[8] the wire harness according to any one of aspects [1] to [7]; and a power supply control device configured to supply power to the lighting member when the sliding door enters an open state.

According to this configuration, when the sliding door is in the open state, the power supply control device supplies power to the lighting member, and therefore, even at night, for example, the position of the wire harness can be easily checked when the sliding door is opened.

[9] A configuration is possible in which, in aspect [8], the power supply control device supplies power to the lighting member such that a manner of lighting is different between when the sliding door is in operation and when the sliding door is in a fully open state.

According to this configuration, power is supplied to the lighting member such that the manner of lighting is different between when the sliding door is in operation and when the sliding door is in the fully open state, and therefore, for example, the user can recognize that the sliding door is in operation.

[10] A configuration is possible in which, in aspect [8] or [9], the power supply control device supplies power to the lighting member also when the sliding door is in a fully closed state.

According to this configuration, power is supplied to the lighting member also when the sliding door is in the fully closed state, such that, for example, an illumination effect can be provided.

[11] A configuration is possible in which, in any one of aspects [8] to [10], the lighting system further includes: a switch configured to switch between supplying and stopping power to the lighting member when the sliding door is in a fully closed state.

According to this configuration, when the sliding door is in the fully closed state, the switch can switch between supplying and stopping power to the lighting member, and therefore, for example, the passenger can light up the lighting member as needed.

### Details of Embodiments of the Present Disclosure

Specific examples of a lighting system of the present disclosure will be described below with reference to the drawings. In the drawings, some parts of configurations may be exaggerated or simplified for convenience of description. Furthermore, the dimensional ratios of members may differ between drawings.

The terms “first”, “second”, and the like used in this specification are used merely to distinguish between objects, and do not rank the objects. The present disclosure is not limited to these examples, but rather is defined by the scope of the claims, and is intended to include all modifications within the meaning and scope equivalent to the claims.

### (Configuration of Lighting System 1)

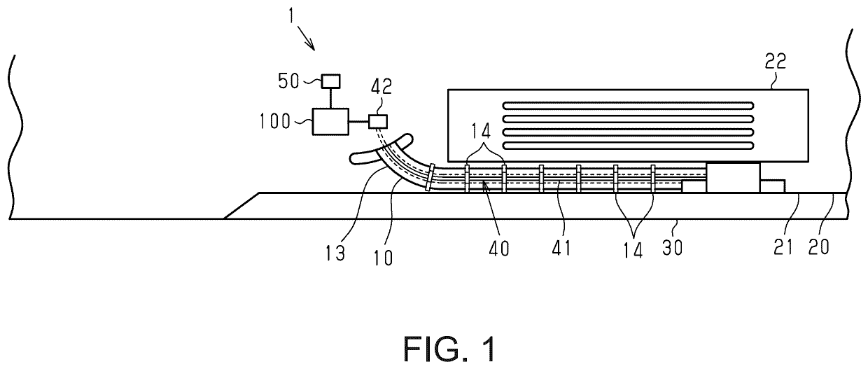

As shown in FIGS. 1 to 3, a lighting system 1 includes a wire harness 10 and a power supply control device 100. The lighting system 1 is provided for a vehicle body 20 and a sliding door 30 of a vehicle.

### (Configuration of Wire Harness 10)

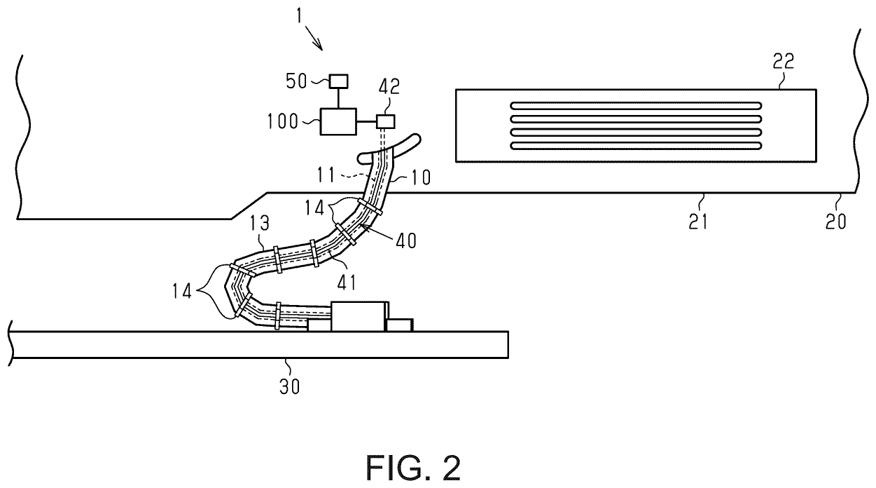

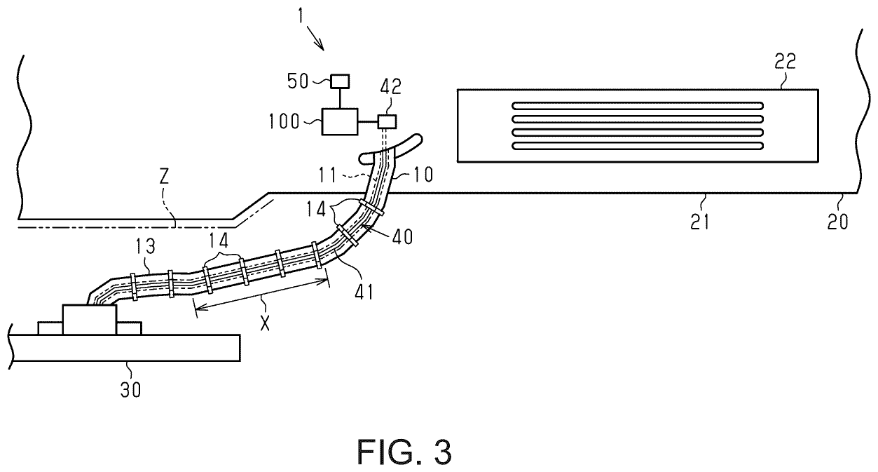

The wire harness 10 includes a group of electric wires 11 routed from the vehicle body 20 to the sliding door 30. The electric wires 11 electrically connect the power supply control device 100 provided in the vehicle body 20 to electric devices (not shown) provided in the sliding door 30. Examples of such electric devices include a power window motor and a lock actuator, and the power supply control device 100 is a device for supplying power to these electric devices. The vehicle body 20 has an opening portion 21 that can be opened and closed by the sliding door 30. The vehicle body 20 is also provided with an entrance/exit step 22. The entrance/exit step 22 is provided at a position that corresponds to the sliding door 30 and is inward of (in FIG. 1, upward of) the outer (in FIG. 1, lower) end of the opening portion 21. The entrance/exit step 22 is for a user to place their feet on when getting in and out of the vehicle. Also, the sliding door 30 is provided so as to be slidable toward the front and back (in FIG. 1, right and left) of the vehicle body 20 by a mechanism (not shown). More specifically, the sliding door 30 in a fully closed state (see FIG. 1) can be slid outward (downward in FIG. 1) from the vehicle body 20 and toward the rear (leftward in FIG. 2) of the vehicle body 20 by a mechanism (not shown), and can be slid to a fully open state (see FIG. 3).

As shown in FIG. 6, the wire harness 10 includes a group of electric wires 11, cable carrier links 12, a rubber boot 13 serving as an exterior member, fixing members 14, and a light guide 41 that constitutes part of a lighting member 40. Note that FIG. 6 illustrates portions of the wire harness 10 in a partially disassembled state. The electric wires 11 include a plurality of electric wires bundled together, but in the figures, the electric wires are schematically shown as a group and are not shown individually.

### (Configuration of Cable Carrier Link 12)

The cable carrier links 12 are made of a resin material.

The cable carrier links 12 cover the electric wires 11, are aligned along the extending direction of the electric wires 11, and are rotatably connected to each other.

Specifically, each of the cable carrier links 12 includes a U-shaped cable carrier body 15 having an opening on one side in a direction intersecting the extending direction of the electric wires 11, and a carrier cover 16 fixed so as to close the opening of the cable carrier body 15.

The cable carrier body 15 has a rotation shaft portion 15a at a first end portion, and a rotation shaft receiving portion 15b, to which the rotation shaft portion 15a can be connected, at a second end portion. Each of the cable carrier bodies 15 can be rotatably connected to the rotation shaft receiving portion 15b of another cable carrier body 15 with an adjacent rotation shaft portion 15a, and can rotate relative to the adjacent other cable carrier body 15.

As shown in FIGS. 7 and 8, there are two types of cable carrier links 12 in the present embodiment, namely a first cable carrier link 12a (see FIG. 7) and a second cable carrier link 12B (see FIG. 8) that have different rotation angles. As shown in FIG. 7, the first cable carrier link 12A can rotate 15° in a first rotation direction (counterclockwise in the figure) from a straight state, and can rotate 30° in a second rotation direction (clockwise in the figure) from the straight state. Also, as shown in FIG. 8, the second cable carrier link 12B cannot rotate in the first rotation direction (counterclockwise in the figure) from the straight state, but can rotate 45° in the second rotation direction (clockwise in the figure) from the straight state. Note that the rotation angle of each of the cable carrier links 12 is set using a known structure such as changing the shape of the portion that engages with the adjacent cable carrier link 12.

When the cable carrier links 12 are connected, the first cable carrier links 12a and the second cable carrier links 12b are combined such that the wire harness 10 does not protrude toward the vehicle body 20 (upward in FIG. 3) beyond a protrusion prevention line Z (see FIG. 3). Note that the protrusion prevention line Z is a line set for each vehicle type so as to maintain a certain distance from the vehicle body 20 while extending along the vehicle body 20, for example.

As shown in FIG. 3, for example, in the present embodiment, the second cable carrier links 12B (see FIG. 8) are used in an intermediate range X of the wire harness 10. This prevents the wire harness 10 from protruding beyond the protrusion prevention line Z toward the vehicle body 20 (upward in FIG. 3). The wire harness 10 is thereby prevented from colliding with the vehicle body 20. The first cable carrier links 12A (see FIG. 7) are used outside the intermediate range X in the wire harness 10. Of course, the combination of the first cable carrier links 12A and the second cable carrier links 12B may be changed as appropriate in accordance with, for example, the protrusion prevention line Z set for each vehicle type.

### (Configuration of Rubber Boot 13)

The rubber boot 13 is made of a rubber material.

As shown in FIG. 6, the rubber boot 13 extends along the extending direction of the electric wires 11 and is provided so as to cover the electric wires 11. Specifically, the rubber boot 13 is provided so as to cover the rotatably connected cable carrier links 12. The rubber boot 13 has a bellows structure with repeating recesses and protrusions in the extending direction. The rubber boot 13 is formed so as to be easily bendable due to the bellows structure, thereby allowing the cable carrier links 12 to rotate.

### (Configuration of Lighting Member 40)

As shown in FIGS. 1 to 3, the lighting member 40 includes a light guide 41 and a light emitting member 42 (light emitter). The light emitting member 42 in the present embodiment is, for example, a light emitting diode (i.e., an LED). Moreover, the color of light emitted by the light emitting member 42 in the present embodiment is white. The light emitting member 42 is connected to the power supply control device 100 provided in the vehicle body 20, and emits light when power is received from the power supply control device 100. The light guide 41 has an elongated shape, and disperses and emits light supplied by the light emitting member 42 while guiding the light along the extending direction of the light guide 41. In other words, the light guide 41 has a first end portion connected to the light emitting member 42, and disperses and emits light supplied by the light emitting member 42 while guiding the light toward a second end portion. The light guide 41 is provided in the wire harness 10 so as to extend along the extending direction of the electric wires 11. The light guide 41 of the present embodiment extends over the entirety of the wire harness 10 in the extending direction. The light guide 41 is fixed to the rubber boot 13 by a plurality of fixing members 14.

### (Configuration of Fixing Member 14)

As shown in FIG. 6, the fixing members 14 are arranged at intervals in the extending direction of the rubber boot 13. Each of the fixing members 14 has a fixing portion 14a fixed to a portion of the rubber boot 13 in the extending direction, and a holding portion 14b that holds the light guide 41. The fixing portion 14a is configured so as to be fixed to the rubber boot 13 in a direction intersecting the extending direction of the rubber boot 13. The fixing portion 14a is formed to fit into a recess 13a in the bellows structure of the rubber boot 13. The holding portion 14b is configured to be able to hold the light guide 41 in a direction intersecting the extending direction of the light guide 41.

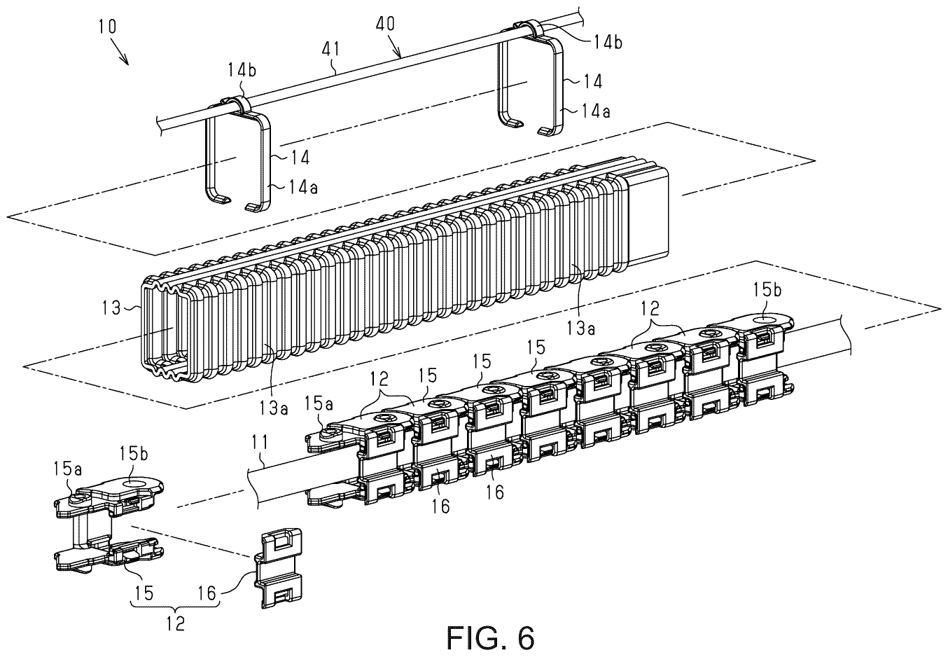

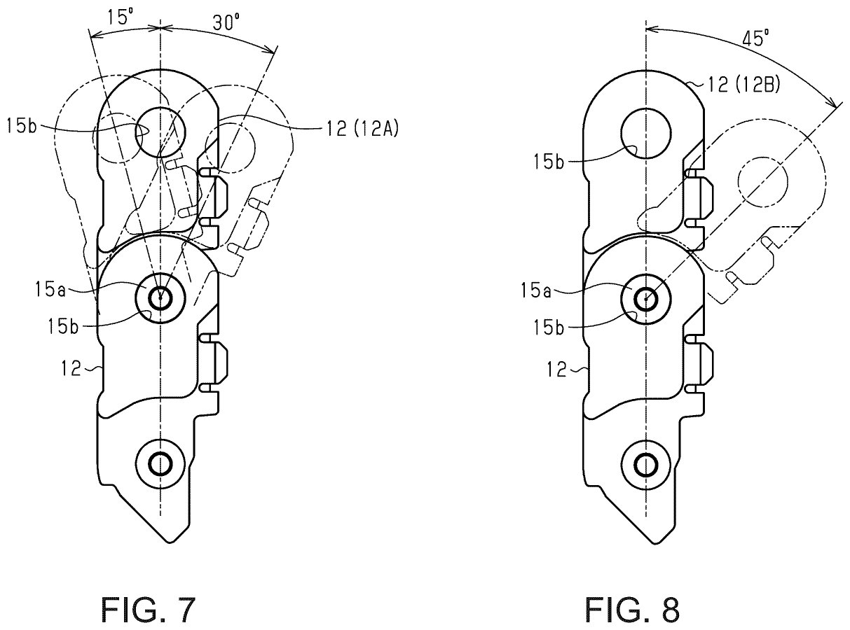

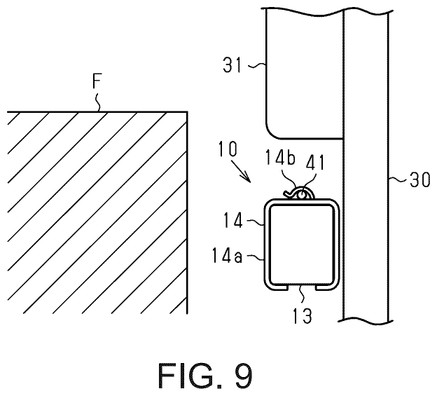

Specifically, as shown in FIG. 5, the fixing portion 14a has an upper piece 14c, side pieces 14d extending downward in parallel from the two sides of the upper piece 14c, and claw pieces 14e extending toward each other from the tips of the side pieces 14d. The fixing portion 14a is fixed to the rubber boot 13 by being bent such that the claw pieces 14e move apart to widen the gap therebetween, and then being fitted from above into one of the recesses 13a of the rubber boot 13 (see FIG. 6).

Also, as shown in FIG. 5, the holding portion 14b has an arc piece 14f that extends in an arc shape from the upper surface of the upper piece 14c while extending along the upper piece 14c, and an introduction piece 14g that extends upward from the tip of the arc piece 14 f while extending along the upper piece 14c. The arc piece 14f is bent such that the gap between the tip of the arc piece 14f and the upper piece 14c widens, and then the light guide 41 (see FIG. 6) is fitted therein from the side, thus holding the light guide 41 in the holding portion 14b. In other words, the light guide 41 passes between the upper piece 14c and the introduction piece 14g and is inserted between the upper piece 14 c and the arc piece 14f, and is thereby held by the holding portion 14b.

As shown in FIGS. 1 to 3, the light guide 41 fixed as described above is positioned at the widthwise center of the upper surface of the wire harness 10, and bends together with the wire harness 10 when the sliding door 30 operates.

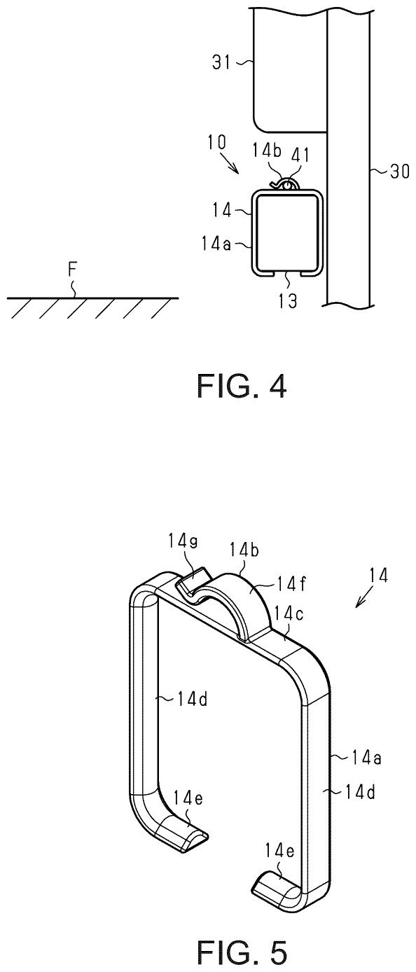

As shown in FIG. 4, the light guide 41 of the present embodiment is set so as to be disposed higher than the floor F when the sliding door 30 is in the fully closed state. FIG. 4 illustrates a door trim 31 provided on the sliding door 30, and the wire harness 10 is located lower than the door trim 31 when the sliding door 30 is in the fully closed state.

(Configuration of power supply control device 100)

The power supply control device 100 is electrically connected to a battery (not shown), a courtesy switch (not shown), and the like. The power supply control device 100 supplies power to the lighting member 40, more specifically to the light emitting member 42 of the lighting member 40, when the sliding door 30 enters the open state (see FIGS. 2 and 3). Note that in the present embodiment, open states of the sliding door 30 include a semi open state (see FIG. 2) in which the sliding door 30 is in operation, and a fully open state of the sliding door 30 (see FIG. 3). Furthermore, the power supply control device 100 of the present embodiment supplies power to the light emitting member 42 of the lighting member 40 also when the sliding door 30 enters the fully closed state (see FIG. 1).

As shown in FIG. 1, the lighting system 1 of the present embodiment includes a switch 50. The switch 50 is electrically connected to the power supply control device 100. The switch 50 is provided at a position where it can be operated by a passenger. The switch 50 is configured to be able to switch between supplying and stopping power to the light emitting member 42 of the lighting member 40 when the sliding door 30 enters the fully closed state.

### (Operations of Present Embodiment)

Next, operations of the lighting system 1 configured as above will be described.

For example, when the sliding door 30 enters the open state (see FIGS. 2 and 3), power is supplied from the power supply control device 100 to the light emitting member 42 of the lighting member 40. The light emitting member 42 thus emits light, and the entirety of the light guide 41 in the extending direction is illuminated. Therefore, for example, even at night, the user can easily see the position of the wire harness 10 that includes the light guide 41 when, for example, getting in and out of the vehicle.

Also, in the present embodiment, also when the sliding door 30 is in the fully closed state, power is supplied from the power supply control device 100 to the light emitting member 42 of the lighting member 40, and thus the entirety of the light guide 41 in the extending direction is illuminated. Therefore, for example, a passenger can enjoy the light guide 41 as illumination.

### (Effects of Present Embodiment)

Next, effects of the above embodiment will be described.

(1) The wire harness 10 includes the lighting member 40 that extends along the extending direction of the electric wires 11, and therefore, for example, even at night, the user can easily check the position of the wire harness 10 when the sliding door 30 is opened. Therefore, it is possible to reduce the possibility of the wire harness 10 being stepped on. Specifically, for example, when the sliding door 30 is opened, a lower arm (not shown) that constitutes a portion of the opening and closing mechanism of the sliding door 30 may be located below the wire harness 10. In such a case, particularly when a child gets in or out of the vehicle, for example, they may try to put their feet on the lower arm, and thus there is a risk that the wire harness 10 may be stepped on, but the light guide 41 of the lighting member 40 emits light and thus is less likely to be stepped on. Furthermore, because the light guide 41 of the lighting member 40 emits light, the visibility of the surrounding area including the lower arm is improved, and for example, the visibility of a “do not step” mark on the lower arm is improved, thereby making it less likely for the lower arm and wire harness 10 to be stepped on.

(2) The lighting member 40 includes the light emitting member 42 and the light guide 41 that extends along the extending direction of the electric wires 11 and disperses and emits the light supplied by the light emitting member 42 while guiding the light along the extending direction. Therefore, good visibility can be achieved with a simple configuration. For example, a simple configuration including the light emitting member 42 and one light guide 41 can be used to provide long and continuous lighting in the extending direction of the electric wires 11. This configuration requires fewer components than, for example, a case in which a large number of light emitting members such as LEDs are aligned along the extending direction of the electric wires 11.

(3) The rubber boot 13 includes the fixing members 14, each having the fixing portion 14a fixed to a portion of the rubber boot 13 in the extending direction, and the holding portion 14b that holds the light guide 41, and the fixing members 14 are arranged at intervals in the extending direction of the rubber boot 13. Therefore, the light guide 41 can be easily routed along the wire harness 10.

(4) The holding portion 14b is configured to be able to hold the light guide 41 from a direction intersecting the extending direction of the light guide 41, and therefore, for example, there is no need to route the light guide 41 along the extending direction in advance, and so-called retrofitting is possible. Therefore, assembly is easier.

(5) The fixing portion 14a is configured so as to be fixed to the rubber boot 13 from a direction intersecting the extending direction of the rubber boot 13, and therefore, for example, there is no need to route the rubber boot 13 along the extending direction in advance, and so-called retrofitting is possible. Therefore, assembly is easier.

(6) The fixing portion 14a is formed so as to be fitted into one of the recesses 13a in the bellows structure of the rubber boot 13, and therefore positional deviation in the extending direction of the rubber boot 13 can be prevented with a simple structure.

(7) The wire harness 10 includes the cable carrier links 12 that cover the electric wires 11, are aligned along the extending direction of the electric wires 11, and are rotatably connected to each other, thus making it possible to, for example, stabilize the position of the wire harness 10. For example, with a configuration in which the electric wires 11 are merely covered with a simple corrugated tube, the wire harness 10 can bend freely at any position in the extending direction, and the manner of bending may change due to deterioration or the like, and therefore the position of the wire harness 10 is not stable. In contrast, the cable carrier links 12 can maintain a constant manner of bending even when the sliding door 30 is repeatedly opened and closed, and therefore the position of the wire harness 10 can be stabilized. Therefore, for example, it is possible to prevent the wire harness 10 from protruding to a position where it is likely to be stepped on.

Furthermore, for example, if the electric wires 11 are merely covered with a simple corrugated tube, they may deform so as to overall form a large arc when bent, for example, and thus may penetrate into an undesired area, and may even come into contact with another member. In contrast, the cable carrier links 12 can maintain a constant manner of bending, thus making it possible to stably prevent contact with another member. Specifically, the wire harness 10 is prevented from protruding beyond the protrusion prevention line Z toward the vehicle body 20, and thus is prevented from colliding with the vehicle body 20.

(8) When the sliding door 30 enters the open state, the power supply control device 100 supplies power to the light emitting member 42 of the lighting member 40, and therefore, even at night, for example, the position of the wire harness 10 can be easily checked when the sliding door 30 is open.

(9) Also when the sliding door 30 enters the fully closed state, power is supplied by the power supply control device 100 to the light emitting member 42 of the lighting member 40, such that, for example, an illumination effect can be provided.

(10) When the sliding door 30 is in the fully closed state, the switch 50 can switch between supplying and stopping power to the light emitting member 42 of the lighting member 40, and therefore, for example, the passenger can light up the light guide 41 of the lighting member 40 as needed.

### MODIFIED EXAMPLES

The above embodiment can be modified as follows. The above-described embodiment and the following modified examples can be implemented in combination with each other as long as no technical contradiction occurs.

In the above embodiment, the light guide 41 is located higher than the floor F inside the vehicle compartment when the sliding door 30 is in the fully closed state, but the present disclosure is not limited to this.

For example, as shown in FIG. 9, the light guide 41 may be arranged at a position lower than the floor F. In this case, light leaking from below the floor F can have an illumination effect, for example.

In the above embodiment, the power supply control device 100 supplies power such that the light emitting member 42 of the lighting member 40 lights up when the sliding door 30 enters the fully closed state, when the sliding door 30 enters the fully open state, and while the sliding door 30 is in operation, but the present disclosure is not limited to this.

For example, the power supply control device 100 may be configured to supply power to the light emitting member 42 of the lighting member 40 such that the manner of lighting is different between when the sliding door 30 is in operation and when the sliding door 30 is in the fully open state. Specifically, for example, the power supply control device 100 may supply power such that the light emitting member 42 flashes while the sliding door 30 is in operation, and may supply power such that the light emitting member 42 lights up continuously when the sliding door 30 is in the fully open state. Furthermore, for example, the power supply control device 100 may be configured to supply power to the light emitting member 42 such that the color of light that is emitted while the sliding door 30 is in operation (e.g., red) is different than when the sliding door 30 is in the fully open state. Note that in this case, the light emitting member 42 needs to be configured to be able to emit light in multiple colors.

According to this configuration, the manner of lighting of the lighting member 40 is different between when the sliding door 30 is in operation and when the sliding door 30 is in the fully open state, and therefore, for example, the user can recognize that the sliding door 30 is in operation.

In the above embodiment, the lighting member 40 includes the light guide 41 and the light emitting member 42, but the present disclosure is not limited to this, and may be changed to a lighting member having another configuration extending along the extending direction of the electric wires 11. Furthermore, although it is described that the lighting member 40 lights up when power is supplied, the present disclosure is not limited to this.

For example, the lighting member may be a rubber boot 13 that contains a phosphorescent material. In other words, the rubber material from which the rubber boot 13 is made may contain a phosphorescent material. Note that a phosphorescent material is a material that stores light, and emits light even when no longer irradiated with light.

Furthermore, the lighting member 40 may be changed to another configuration in which a plurality of lighting members are aligned along the extending direction of the electric wires 11. For example, the lighting member may be constituted by a large number of light emitting members such as LEDs aligned along the extending direction of the electric wires 11. Specifically, for example, the fixing members 14 shown in FIGS. 1 to 3 may be replaced with light emitting members such as LEDs that are fixed to the outer surface of the rubber boot 13.

Even with this configuration, the user can easily check the position of the wire harness 10. Therefore, it is possible to reduce the possibility of the wire harness 10 being stepped on.

In the above embodiment, the wire harness 10 includes the fixing members 14 that each have the fixing portion 14a fixed to a portion of the rubber boot 13 in the extending direction, and the holding portion 14b holding the light guide 41, but the present disclosure is not limited to this. In other words, the light guide 41 may be provided in the wire harness 10 with another configuration.

In the above embodiment, the holding portion 14b of the fixing member 14 is configured to be able to hold the light guide 41 in a direction intersecting the extending direction of the light guide 41, but the present disclosure is not limited to this.

In the above embodiment, the fixing portion 14a of the fixing member 14 is configured to be able to be fixed to the rubber boot 13 in a direction intersecting the extending direction of the rubber boot 13, but the present disclosure is not limited to this.

In the above embodiment, the fixing portion 14a of the fixing member 14 is formed so as to fit into one of the recesses 13a of the bellows structure of the rubber boot 13, but the present disclosure is not limited to this. Note that in this case, positional deviation of the fixing member 14 relative to the extending direction of the rubber boot 13 needs to be prevented using another configuration.

In the above embodiment, the wire harness 10 includes a plurality of cable carrier links 12 that cover the electric wires 11, are aligned along the extending direction of the electric wires 11, and are rotatably connected to each other, but the present disclosure is not limited to this. For example, the wire harness may have a configuration in which the electric wires 11 are covered with a corrugated tube.

In the above embodiment, the lighting system 1 includes the power supply control device 100 that supplies power to the light emitting member 42 of the lighting member 40 when the sliding door 30 enters the open state, but the present disclosure is not limited to this. For example, rather than automatically supplying power when the sliding door 30 enters the open state, the power supply control device 100 may be configured to supply power to the light emitting member 42 based on an operation performed on the switch 50.

In the above embodiment, the power supply control device 100 supplies power to the light emitting member 42 of the lighting member 40 also when the sliding door 30 enters the fully closed state, but the present disclosure is not limited to this. For example, rather than automatically supplying power when the sliding door 30 enters the fully closed state, the power supply control device 100 may be configured to supply power to the light emitting member 42 based on an operation performed on the switch 50. Furthermore, for example, the power supply control device 100 may be configured to stop the supply of power to the light emitting member 42 when a preset time (e.g., 10 seconds or 15 seconds) has elapsed since the sliding door 30 entered the fully closed state.

In the above embodiment, the lighting system 1 includes the switch 50 that can switch between supplying and stopping power to the light emitting member 42 of the lighting member 40 when the sliding door 30 is in the fully closed state, but the present disclosure is not limited to this.

In the above embodiment, there are two types of cable carrier links 12, namely the first cable carrier link 12A and the second cable carrier link 12B that have different rotation angles, but the present disclosure is not limited to this. For example, the cable carrier links 12 may be a single type of cable carrier link 12 with a fixed rotation angle, or three or more types of cable carrier links 12 with different rotation angles may be used.

In the above embodiment, the wire harness 10 includes the rubber boot 13 as the exterior member/exterior cover, but the present disclosure is not limited to this, and the wire harness 10 may be configured without the rubber boot 13. In other words, a configuration may be adopted in which the cable carrier links 12 are exposed to the outside. Also, the wire harness 10 may be configured to include an exterior member other than the rubber boot 13 that covers the electric wires 11.

In the above embodiment, the light emitting member 42 is a light emitting diode (i.e., an LED), but the present disclosure is not limited to this, and, for example, another type of light emitting member 42 such as a light bulb may be used.

The embodiments disclosed herein are examples in all respects, and the present disclosure is not limited to these examples. In other words, the scope of the present disclosure is defined by the claims, and is intended to include all modifications that are within the meaning and scope of the claims.

What is claimed is:

1. A wire harness comprising:
a plurality of electric wires that is configured to be routed from a vehicle body to a sliding door that opens and closes relative to the vehicle body; and
at least one lighting member that extends along an extending direction of the plurality of electric wires and is aligned along the extending direction of the plurality of electric wires.

2. The wire harness according to claim 1,
wherein each lighting member of the at least one lighting member includes a light emitter and a light guide that extends along the extending direction of the plurality of electric wires and that disperses and emits light supplied by the light emitter while guiding the light along an extending direction of the light guide.

3. The wire harness according to claim 2, further comprising:
an exterior cover that is configured to cover the plurality of electric wires while extending along the extending direction of the plurality of electric wires; and
a plurality of fixing members that is configured to be arranged at intervals in an extending direction of the exterior cover, each fixing member of the plurality of fixing members having a fixing portion configured to be fixed to a portion of the exterior cover in the extending direction of the exterior cover, and a holding portion configured to hold the light guide.

4. The wire harness according to claim 3,
wherein each holding portion of the holding portions is configured to hold the light guide from a direction intersecting the extending direction of the light guide.

5. The wire harness according to claim 3,
wherein each fixing portion of the fixing portions is configured to be fixed to the exterior cover from a direction intersecting the extending direction of the exterior cover.

6. The wire harness according to claim 5, wherein:
the exterior cover is a rubber boot having a bellows structure with repeating recesses and protrusions in the extending direction of the exterior cover, and
the fixing portions are fitted into the recesses of the bellows structure of the rubber boot.

7. The wire harness according to claim 1, further comprising:
a plurality of cable carrier links that is configured to cover the plurality of electric wires, be aligned along the extending direction of the plurality of electric wires, and be rotatably connected to each other.

8. A lighting system comprising:
the wire harness according to claim 1; and
a power supply controller that is configured to supply power to the at least one lighting member when the sliding door enters an open state.

9. The lighting system according to claim 8,
wherein the power supply controller is configured to supply power to the at least one lighting member such that a manner of lighting is different between when the sliding door is in operation and when the sliding door is in a fully open state.

10. The lighting system according to claim 8,
wherein the power supply controller is configured to supply power to the at least one lighting member also when the sliding door is in a fully closed state.

11. The lighting system according to claim 8, further comprising:
a switch that is configured to switch between supplying and stopping power to the at least one lighting member when the sliding door is in a fully closed state.
